(19) United States
(12) Patent Application Publication
(10) Pub. No.: US 2012/0093368 A1
(43) Pub. Date: Apr. 19, 2012

(54) ADAPTIVE SUBJECT TRACKING METHOD, APPARATUS, AND COMPUTER READABLE RECORDING MEDIUM

(75) Inventors: Song Ki Choi, Seoul (KR); Chung Bin Heo, Seoul (KR)

(73) Assignee: OLAWORKS, INC., Seoul (KR)

(21) Appl. No.: 13/377,950

(22) PCT Filed: Nov. 18, 2010
(86) PCT No.: PCT/KR10/08163

§ 371 Date: Dec. 13, 2011

(30) Foreign Application Priority Data
Nov. 23, 2009 (KR) 10-2009-0113560

(51) Int. Cl. G06K 9/00

(52) U.S. Cl. 382/103

(57) ABSTRACT

The present invention relates to a method for adaptively tracking a subject. The method includes the steps of: comparing a first block which indicates a region corresponding to a specific subject in a first frame with at least one block included in a second frame and determining a specific block among at least one block in the second frame which has the highest degree of similarity to the first block as a second block which indicates a region corresponding to the specific subject in the second frame; and detecting the specific subject from at least part of the whole region in the second frame by using a subject detection technology, if the degree of similarity between the first block and the second block is less than a predetermined threshold value, and resetting the second block in the second frame based on a region corresponding to the detected specific subject.

### FIELD OF THE INVENTION

The present invention relates to a method, an apparatus and a computer-readable recording medium for adaptively tracking a subject; and more particularly, to the method, the apparatus and the computer-readable recording medium for performing subject tracking in a Video more rapidly and more accurately by selectively using a subject detection technology and a block matching technology and providing an algorithm for adaptively tracking a subject included in frames of a video, e.g., a person's face.

### BACKGROUND OF THE INVENTION

Recently, as functions of digital cameras, mobile phones and other camera devices for shooting videos become more intelligent and smarter, users' expectations for artificial intelligence functions in camera devices have been increasing, and therefore, a function for tracking a region of a face in a video has been introduced as a basic function of such camera devices. Furthermore, given limited computational speeds of mobile camera devices, which are difficult to have high performance processors, and computational loads caused by other essential processes, which must run in such mobile camera devices, a more effective face tracking technology is required.

If a subject detection technology is applied to track a subject such as a face in a video in the whole region of each frame of the video, a rapid execution time cannot be expected. To track the subject more effectively, another proper subject tracking technology is required.

First of all, as an example of conventional subject tracking technology, there is a technology for basically applying a partial detection process only to a region around a detected subject on the previous frame (i.e., Partial Detection: PD) and occasionally applying a full detection process to the entire region of some frames in order to improve precision of face tracking (i.e., Full Detection: FD). The conventional technology has an advantage of enhancing the speed of subject tracking by appropriately mixing existing subject detection algorithms, but since the subject detection algorithms are low speed algorithms due to a high computational complexity, it is inappropriate to be applied to the mobile camera devices.

Another example of conventional technology is a technology which uses a block matching algorithm, a mean shift algorithm, or the like. According to another example of conventional technology, it may reduce the execution time compared to the technology which uses the subject detection algorithms because it requires less computational speed but its problem is that a successful tracking rate is not high in the real environment in which an outward appearance, location, etc. of a subject may be significantly changed.

Accordingly, a necessity of a new technology for tracking a subject accurately and seamlessly on a mobile terminal is emerging.

### SUMMARY OF THE INVENTION

It is, therefore, an object of the present invention to solve all the aforementioned problems.

It is another object of the present invention to provide an algorithm for adaptively tracking a subject included on a video frame by selectively employing a subject detection algorithm and a block matching algorithm based on a certain threshold.

It is yet another object of the present invention to adjust a threshold as a criterion of changing a subject tracking method, i.e., either a subject detection method or a block matching method, in consideration of contrast in a video-shooting environment, determine a search region in a block matching process by estimating a movement of the subject, and automatically perform a subject detection process in response to a rapid environment change.

In accordance with one aspect of the present invention, there is provided a method for adaptively tracking a subject, including the steps of: (a) comparing a first block which indicates a region corresponding to a specific subject in a first frame with at least one block included in a second frame and determining a specific block among the at least one block in the second frame which has the highest degree of similarity to the first block as a second block which indicates a region corresponding to the specific subject in the second frame; and (b) detecting the specific subject from at least part of the whole region in the second frame by using a subject detection technology, if the degree of similarity between the first block and the second block is less than a predetermined threshold value, and resetting the second block in the second frame based on a region corresponding to the detected specific subject.

In accordance, with another aspect of the present invention, there is provided an apparatus for adaptively tracking a subject including: a subject detecting part for detecting a specific subject from at least part of the whole region in a video frame; a block matching part for comparing a first block which indicates a region corresponding to the specific subject in a first frame with at least one block included in a second frame and determining a specific block among the at least one block in the second frame which has the highest degree of similarity to the first block as a second block which indicates a region corresponding to the specific subject in the second frame; and a tracking method determining part for resetting the second block in the second frame based on a region corresponding to the specific subject which is detected from at least part of the whole region in the second frame by the subject detecting part, if the degree of similarity between the first block and the second block is less than a predetermined threshold value.

### BRIEF DESCRIPTION OF THE DRAWINGS

The above objects and features of the present invention will become more apparent from the following description of the preferred embodiments given in conjunction with the accompanying drawings, in which:

FIGS. 1 and 2 are diagrams exemplarily representing an internal configuration of a subject tracking apparatus in accordance with an example embodiment of the present invention.

FIG. 3 is a drawing exemplarily showing a configuration for performing block matching in accordance with an example embodiment of the present invention.

FIG. 4 is a state diagram exemplarily illustrating a course of determining a subject tracking method in accordance with an example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specified embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

Herein, detecting a subject “directly” from a certain video frame means a method for finding the subject included in the certain video frame by using only information on a pixel(s) of the certain video frame without referring to any other frames temporally adjacent to the certain video frame and it must be understood to be distinguished from a block matching algorithm which searches the subject included in the certain video frame by referring to other frames temporally adjacent to the certain video frame.

### Configuration of Subject Tracking Apparatus

Below is a detailed explanation on an internal configuration of a subject tracking apparatus and a function of each component thereof which performs important roles for implementing the present invention.

In accordance with an example embodiment of the present invention, a digital device which has a memory means and a micro processor with a calculation ability such as a personal computer (e.g., desktop, laptop, etc.), a server, a workstation, a PDA, a web pad, a cellular phone, a camera device, etc. may be adopted as the subject tracking apparatus 100 in the present invention.

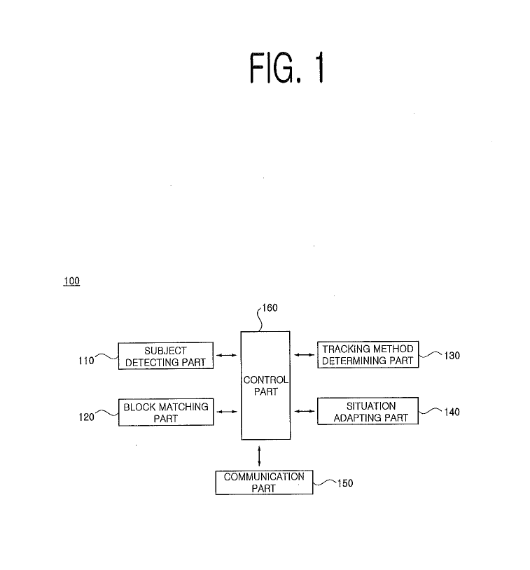

FIG. 1 exemplarily represents the internal configuration of the subject tracking apparatus in accordance with an example embodiment of the present invention.

By referring to FIG. 1, the subject tracking apparatus 100 in accordance with an example embodiment of the present invention may include a subject detecting part 110, a block matching part 120, a tracking method determining part 130, a situation adapting part 140, a communication part 150 and a control part 160 and the situation adapting part 140 may include a threshold adjusting part 141, a subject movement estimating part 142 and an automatic renewal part 143. In accordance with an example embodiment of the present invention, at least some of the subject detecting part 110, the block matching part 120, the tracking method determining part 130, the situation adapting part 140, the communication part 150 and the control part 160 may be program modules communicating with an external system (not illustrated). The program modules may be included in the subject tracking apparatus 100 in a form of an operating system, an application program module and other program modules and may be also stored on several memory devices physically. Furthermore, the program modules may be stored on remote memory devices communicable to the subject tracking apparatus 100. The program modules may include but not be subject to a routine, a subroutine, a program, an object, a component, and a data structure for executing a specific operation or a type of specific abstract data that will be described in accordance with the present invention.

First, the subject detecting part 110 in accordance with an example embodiment of the present invention may perform a function of detecting a subject (e.g., a person's face) included in a frame in a video, such as a movie, a preview, etc., by using a certain subject detection algorithm. More specifically, the subject detecting part 110 in accordance with an example embodiment of the present invention may detect the subject for the entire region of the frame, i.e., all pixels which constitute the frame (i.e., Full Detection: FD); or for a partial region of the frame, i.e., pixels only set as a search region (i.e., Partial Detection: PD). As explained below, a region which the subject detected by the subject detecting part 110 occupies in the frame may be used as a reference block during a course of block matching.

As mentioned above, to detect the subject included in the video frame by the subject detecting part 110, a certain subject detection technology must be adopted. As the certain subject detection technology, an article titled “Vector Boosting for Rotation Invariant Multi-View Face Detection” authored jointly by Chang HUANG and three others and published in “ICCV (International Conference on Computer Vision)” in 2005 may be referred to (The whole content of the article may be considered to have been combined herein). The article describes how to detect a face region accurately by the vector boosting algorithm capable of distinguishing various angles of a subject included in an image even though a face included in the image is leaned at a specific angle. Of course, the subject detection technology applicable to the present invention is not limited only to the method described in the aforementioned article and it will be able to reproduce the present invention by applying various examples.

By referring to a location of the subject in a first frame of a video, the block matching part 120 in accordance with an example embodiment of the present invention may perform a function of determining a location of the subject in a second frame of the video by using the block matching (BM) technology.

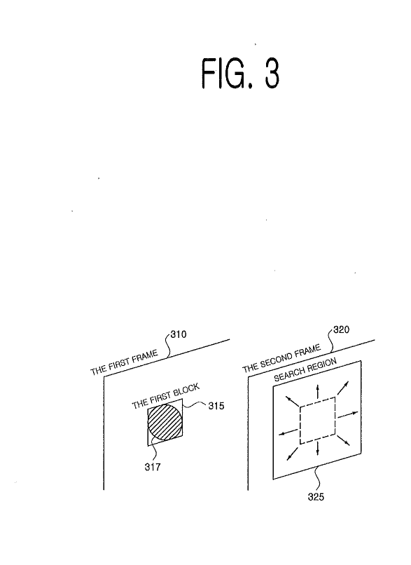

FIG. 3 is a drawing exemplarily expressing a configuration of performing block matching in accordance with an example embodiment of the present invention. By referring to FIG. 3, the block matching part 120 may continuously track a specified subject included in consecutive frames by performing block matching for two temporally adjacent frames 310 and 320. A process for tracking a subject A 317 in a first frame 310 and a second frame 320 is explained in details. For reference, it may be assumed that the first frame 310 and the second frame 320 have same pixel arrangement and the first frame 310 temporally precedes the second frame 320 in a time domain.

In accordance with an example embodiment of the present invention, a first block 315 with a size, of MxN pixels which indicates the subject A 317 included in the first frame 310 may be determined. The first block may be determined from the direct detection of the subject A 317 on the first frame 310 by using the subject detection technology or the like as mentioned above.

In accordance with an example embodiment of the present invention, the block matching part 120 may search at least a region 325 of the second frame 320 to find what is best matched with the first block 315 of the second frame 320, where a location of the region 325 of the second frame may be determined on the basis of the location of the. first block 315 of the first frame 310. For example, the location of the region 325 may be determined as a rectangular region with a size of XxY pixels (X>M, Y>N) whose center is the location of the first block 315 of the first frame 310. To be brief, the block matching part 120 in accordance with an example embodiment of the present invention may determine, as the second block which indicates the subject A 317 in the second frame 320, what is best matched with the first block 315 among all or some blocks with a size of MxN pixels (i.e., candidate blocks) in the region 325 by comparing the candidate blocks with the first block 315 of the first frame 310.

As a method for calculating degrees of similarity between the candidate blocks and the first block 315, a method for determining that if a residual energy level, e.g., SSD (Sum of Squared Distances) of pixel values, acquired by subtracting values of a specific candidate block from those of the first block 315 (or vice versa) is smaller, a degree of similarity between the specific candidate block and the first block 315 is set to be higher may be adopted but it is not limited only to this and a variety of technologies may be properly adopted within a scope of the objects of the prevent invention which are achievable.

Next, the tracking method determining part 130 in accordance with an example embodiment of the present invention may perform a function of deciding either a subject detection technology or a block matching technology as a method for tracking the subject in the video frame by referring to the result of subject tracking which is performed by the subject detecting part 110 or the block matching part 120.

More concretely, to track the subject in the video frame, the tracking method determining part 130 in accordance with an example embodiment of the present invention may track the subject basically by the block matching technology and if a degree of reliability of the block matching is less than a prefixed threshold value by evaluating the result of the block matching for every frame, it may convert a tracking method from the block matching method to the subject detecting method which has a low speed but a high accuracy.

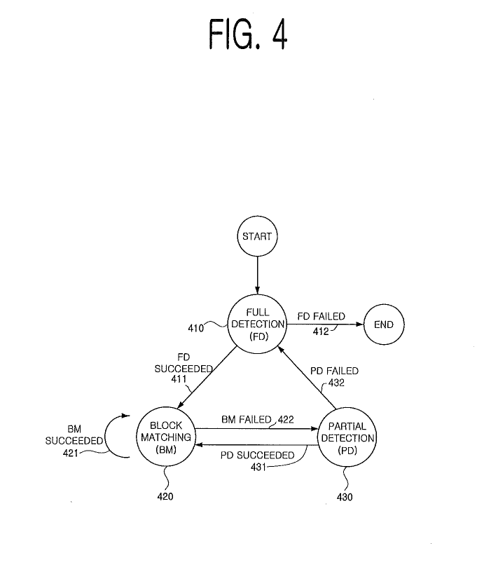

FIG. 4 is a state diagram exemplarily illustrating the process of determining a subject tracking method in accordance with an example embodiment of the present invention. As illustrated in FIG. 4, as a method for tracking the subject in the video frame, the subject tracking apparatus 100 in accordance with an example embodiment of the present invention may adopt one of the following methods selectively: (i) a full detection (FD) method for detecting the subject in the whole region of a frame, i.e., all pixels included in a frame, (ii) a partial detection (PD) method for detecting the subject only in a partial region of the frame, i.e., only pixels set as a search region in the frame, or (iii) a block matching (BM) method for tracking the subject by referring to a block which corresponds to the subject region included in an adjacent frame.

Below will be the explanation on a subject tracking process in accordance with an example embodiment of the present invention. For reference, it is assumed that the subject for tracking is a person's face but it is not limited only to this and other subjects whose shapes may be specified within a video frame will be the subjects for tracking as mentioned in the present invention.

First of all, the subject tracking apparatus 100 in accordance with an example embodiment of the present invention may perform a full detection (FD) for the whole region of a start frame where the subject tracking starts and detect a region corresponding to a face A in the start frame to thereby start a tracking process for the face A as shown at a process of 410. As shown above, the region of the face A detected as a result of performing the full detection to the start frame may be a reference of the block matching to be performed later as shown at a process of 411. If a person's face is not detected even though the full detection was performed for the start frame, the subject tracking process may be ended as shown at a process of 412.

Next, by performing the block matching for two adjacent frames, i.e., a first and a second frames, the subject tracking apparatus 100 in accordance with an example embodiment of the present invention may specify a second block corresponding to the region of the face A in the second frame by referring to a first block corresponding to the region of the face A in the first frame as shown at a process of 420.

More specifically, to find a specific block in the second frame best matched with the first block with a size of MxN pixels included in the first frame, the subject tracking apparatus 100 in accordance with an example embodiment of the present invention may search at least part of regions (a so-called search region) in the second frame. Herein, the at least part of regions in the second frame may be set on the basis of the location of the first block in the first frame. For example, the search region may be set as a rectangular region with a size of XxY pixels whose center is the location of the first block in the first frame (X>M, Y>N). In other words, the subject tracking apparatus 100 in accordance with an example embodiment of the present invention may determine the degrees of similarity by comparing the first block in the first frame with possibly all or some blocks with a size of MxN (i.e., the candidate blocks) in the search region of the second frame and if a specific block best matched with the first block among the blocks in the search region of the second frame has a degree of similarity exceeding the predetermined threshold, the specific block best matched with the first block may be determined as the second block which indicates the region of the subject A in the second frame.

More concretely, if a degree of similarity between the first block in the first frame, i.e., the reference block, and the second block in the second frame as a result of block matching exceeds the predetermined threshold, it may be judged that the result of block matching is reliable. Under the judgment, the subject tracking apparatus 100 in accordance with an example embodiment of the present invention may confirm that the second block is a block indicating the region of the face A in the second frame as shown at a process of 421. To the contrary, if a degree of similarity between the first block in the first frame and the second block in the second frame as the result of block matching is less than the predetermined threshold, it may be judged that the result of block matching is not reliable. Under the judgment, it may perform partial detection (PD) for the search region in the second frame and directly detect the region of the face A in the second frame instead of confirming that the second block is a block indicating the region of the face A in the second frame as shown at a process of 422. For reference, the detailed method for calculating the degree of similarity between the first block and the second block is omitted because it has been sufficiently explained above.

If the degree of reliability of block matching (i.e., the degree of similarity between the first block and the second block) is less than the predetermined threshold, the subject tracking apparatus 100 in accordance with an example embodiment of the present invention may directly detect the region of the face A for a partial region of the frame, i.e., the pixels set as the search region in the frame, and thereby keep the degree of reliability of subject tracking exceeding the predetermined value as shown at a process of 430.

As shown above, if the region of the face A is detected as a result of partial detection (PD) in the search region, the detected region of the face A may be confirmed as a region which indicates the face A in the frame and may become a reference block for a succeeding block matching process to be performed later as shown at a process of 431. To the contrary, if the region of the face A is not detected as the result of partial detection (PD) in the search region, the subject tracking apparatus 100 may perform full detection (FD) for the whole region of the frame to cause the subject tracking process for the face A to continue as shown at a process of 432.

As explained above, to track the subject included in a video frame, the tracking method determining part 130 may properly mix the subject detection method and the block matching method to thereby lead the tracking process for the subject in the video frame to be performed more rapidly and more accurately.

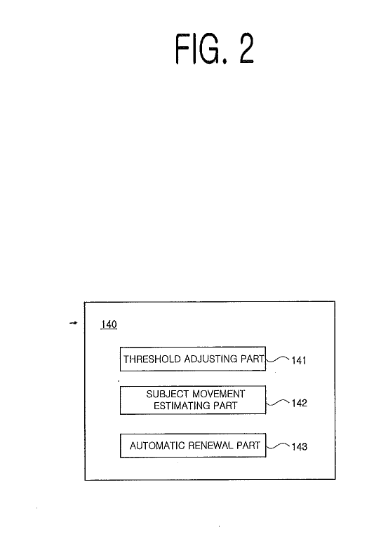

Furthermore, the situation adapting part 140 in accordance with an example embodiment of the present invention may perform a function of instructing the subject tracking algorithm to be adaptively implemented according to a situation where the video is shot (or according to the situation where the movie is inputted in a preview state). By referring to FIG. 2, the situation adapting part 140 in accordance with an example embodiment of the present invention may include the threshold adjusting part 141, the subject movement estimating part 142 and the automatic renewal part 143. Below is a detailed explanation on the function of each component of the situation adapting part 140.

First, the threshold adjusting part 141 in accordance with an example embodiment of the present invention may perform a function of adaptively adjusting the predetermined threshold which serves as a reference for determining a degree of reliability of a result of block matching by referring to the contrast of a photographing environment which may be changed by darkness and brightness of the photographing environment and by features of photographing devices.

For example, if the contrast in the photographing environment is high due to the shooting in a bright place, the residual energy level (e.g., SSD of pixel values) between blocks with a high degree of similarity may be determined to be high. To the contrary, if the contrast in the photographing environment is low due to the shooting in a dark place, the residual energy level between blocks with a low degree of similarity may be determined to be low. Accordingly, if the video frames are shot in a bright environment with a relatively high contrast on the condition that the predetermined threshold which is a reference for determining a degree of reliability of the result of block matching is used with a value of the predetermined threshold being fixed, even though block matching is accurately performed, the residual energy level appears to be high, and therefore, a partial detection or a full detection algorithm is too often called and thereby the speed of subject tracking becomes slower. In addition, if the video frames are shot in a dark environment with a relatively low contrast on the condition that the value of the predetermined value is fixed, even though block matching is not accurately performed, an incorrect subject is continuously tracked without the process being converted to the partial detection or the full detection because the residual energy appears to be low.

To solve the aforementioned problems, the threshold adjusting part 141 in accordance with an example embodiment of the present invention may adaptively adjust the predetermined threshold according to the contrast in the photographing environment changeable by darkness and brightness of the photographing environment and/or by the features of photographing devices. That is, if the contrast of the photographing environment is high, the threshold adjusting part 141 may relatively decrease the predetermined threshold for the degree of similarity and contrarily if the contrast of the photographing environment is low, it may relatively increase the predetermined threshold therefor. Herein, the contrast of the photographing environment may be estimated by intensity variance of pixel values which form a block as a criterion for block matching. For example, it may be estimated as (a proportional factor)×(intensive variance of the pixel values which form the block). But it is not limited only to this and it will be able to be properly changed within a scope of the achievable objects of the prevent invention.

In accordance with an example embodiment of the present invention, the subject movement estimating part 142, furthermore, may perform a function of adaptively setting a location of the search region during the block matching process or during the partial detection process by considering the movements of the subject according to the movements of the hands of a user who takes the video by using a hand-held camera device.

In general, the subject in the video frames may appear to move at a high speed or with an acceleration by the movements of the hands of the user, etc. As technologies for compensating it, conventional technologies such as Kalman filtering have been introduced. But if a subject's estimated movement is reflected as it is to set the search region, there may occur a problem as follows: If the subject suddenly changes its direction due to vibration, shaking, etc. and if the search region is set based on the sudden changes in direction, the subject tracking performance may rather become deteriorated, because even though the search region for the block matching or the partial detection is reset according to the estimated movement of the subject, the subject might move to the opposite direction at the time when the reset search region is actually reflected.

Accordingly, the subject movement estimating part 142 in accordance with an example embodiment of the present invention may solve the aforementioned problems by reflecting only part of the movement (speed, acceleration, etc.) of the subject estimated by a motion estimation technology such as the Kalman filtering, etc. in the reset of the search region in the block matching or the partial detection. For example, the subject movement estimating part 142 may reset the search region for the block matching or the partial detection by reflecting only half of the movement of the estimated subject. By this means, the subject tracking apparatus 100 in accordance with the present invention may prevent the subject tracking process from being incorrectly performed by a hasty estimate for the movement of the subject and thereby respond more flexibly to the movement of the subject.

The automatic renewal part 143 in accordance with an example embodiment of the present invention may automatically renew the subject region in some video frames by calling the full detection (FD) or the partial detection (PD) in response to any rapid change in the outward appearance of the subject due to a change in lighting, a change in a size of the subject in video frames, a change in its position, etc. during the block matching (BM). If the outward appearance of the subject displayed in the video frames is rapidly changed, it is difficult to track the subject only by the block matching method. Therefore, the subject whose outward appearance is suddenly changed may be automatically detected by using the full detection method or the partial detection method in accordance with the present invention, resulting in accurate subject tracking.

A database (not illustrated) in accordance with an example embodiment of the present invention may store video frames which include the subject for tracking. In accordance with the present invention, the database (not illustrated) is a concept of a database not only in a narrow meaning but also in a broad meaning which includes data records, etc. based on computer file systems. From the aspect, it must be understood that, even a set of simple operation processing logs may be the database in the present invention if data can be extracted from the set. The database (not illustrated) may be possibly included in, or configured separately from, the subject tracking apparatus 100 at the necessity of those skilled in the art who implement the present invention.

In addition, the communication part 150 in accordance with an example embodiment of the present invention may perform a function of instructing the subject tracking apparatus 100 to communicate with an external device such as a telecommunications server (not illustrated) or a web server (not illustrated).

Lastly, the control part 160 in accordance with an example embodiment of the present invention may perform a function of controlling data flow among the subject detecting part 110, the block matching part 120, the tracking method determining part 130, the situation adapting part 140 and the communication part 150. Briefly, the control part 160 may control the flow of data from outside or among the components of the subject tracking apparatus 100 and thereby allow the subject detecting part 110, the block matching part 120, the tracking method determining part 130, the situation adapting part 140 and the communication part 150 to perform their unique functions.

In accordance with the present invention, since the algorithm for adaptively tracking the subject included in the video frame is provided, there may be an achievable effect on tracking the subject included in the frames of the video (particularly, face tracking) more rapidly and more accurately.

In accordance with the present invention, for the reason that the adaptive subject tracking algorithm may be provided in consideration of contrast of the photographing environment, the movement of the subject, any change in a situation(s) near the subject, etc., there may be an accomplishable effect on implementing the robust subject tracking technology.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variation equal or equivalent to the patent claims pertain to the category of the thought of the present invention.

1. A method for adaptively tracking a subject comprising the steps of:
(a) comparing a first block which indicates a region corresponding to a specific subject in a first frame with at least one block included in a second frame;
(b) determining a specific block among the at least one block in the second frame which has the highest degree of similarity to the first block, said specific block determined to indicate a region corresponding to the specific subject in the second frame; and
(c) detecting the specific subject from at least part of the whole region in the second frame by using a subject detection technology where the degree of similarity between the first block and the second block is less than a predetermined threshold value, and resetting the second block in the second frame based on a region corresponding to the detected specific subject.

2. The method of claim 1, wherein the first and the second frames are temporally adjacent frames.

3. The method of claim 1, wherein, at the step (a), the first block is set based on the specific subject which is detected by applying the subject detection technology to the whole region in the first frame.

4. The method of claim 1, wherein, at the step of (a), the at least one block included in the second frame exists in a search region, in the second frame, set based on a location of the first block in the first frame.

5. The method of claim 1, wherein the degree of similarity is determined by referring to a sum of squared distances between respective pixel values in the first block and those in the second block.

6. The method of claim 1, wherein, at the step of (c), the detection of the specific subject from the at least part of the whole region in the second frame is performed only for a search region, in the second frame, set based on a location of the first block in the first frame.

7. The method of claim 6, wherein, at the step of (c), if the detection of the specific subject from the search region in the second frame is failed, the specific subject is detected from the whole region in the second frame and the second block in the second frame is reset based on a region corresponding to the specific subject detected by applying the subject detection technology to the whole region in the second frame.

8. The method of claim 1, wherein the step of (c) includes the step of: (c-1) adaptively determining the predetermined threshold value according to a contrast of a photographing environment.

9. The method of claim 8, wherein, at the step of (c-1), if the contrast is higher, the predetermined threshold value is set to be lower.

10. The method of claim 1, wherein the step (c) includes the step of: (c-2) setting a region for a block matching or a subject detection in the second frame by estimating movements of the specific subject and reflecting only part of the estimated movements.

11. The method of claim 1, wherein, the step (c) includes the step of: (c-3) detecting the specific subject from the at least part of the whole region in the second frame by using the subject detection technology and automatically resetting the second block in the second frame based on the region corresponding to the detected specific subject, if there occurs a sudden change between an outward appearance of the specific subject in the first frame and that in the second frame which exceeds the pre-set degree.

12. An apparatus for adaptively tracking a subject comprising:
a subject detecting part for detecting a specific subject from at least part of the whole region in a video frame;
a block matching part for comparing a first block which indicates a region corresponding to the specific subject in a first frame with at least one block included in a second frame and determining a specific block among the at least one block in the second frame which has the highest degree of similarity to the first block as a second block which indicates a region corresponding to the specific subject in the second frame; and
a tracking method determining part for resetting the second block in the second frame based on a region corresponding to the specific subject which is detected from at least part of the whole region in the second frame by the subject detecting part, if the degree of similarity between the first block and the second block is less than a predetermined threshold value.

13. The apparatus of claim 12, wherein the first and the second frames are temporally adjacent frames.

14. The apparatus of claim 12, wherein the first block is set based on the specific subject which is detected by applying the subject detection technology to the whole region in the first frame.

15. The apparatus of claim 12, wherein the at least one block included in the second frame exists in a search region, in the second frame, set based on a location of the first block in the first frame.

16. The apparatus of claim 12, wherein the degree of similarity is determined by referring to a sum of squared distances between respective pixel values in the first block and those in the second block.

17. The apparatus of claim 12, wherein the tracking method determining part performs the detection of the specific subject from the at least part of the whole region in the second frame only for a search region, in the second frame, set based on a location of the first block in the first frame.

18. The apparatus of claim 17, wherein, if the detection of the specific subject from the search region in the second frame is failed, the tracking method determining part detects the specific subject from the whole region in the second frame and resets the second block in the second frame based on a region corresponding to the specific subject detected from the whole region in the second frame by the subject detecting part.

19. The apparatus of claim 12, further comprising a threshold adjusting part for adaptively determining the predetermined threshold value according to a contrast of a photographing environment.

20. The apparatus of claim 19, wherein, if the contrast is higher, the threshold adjusting part sets the predetermined threshold value to be lower.

21. The apparatus of claim 12, further comprising a subject movement estimating part for setting a region for a block matching or a subject detection in the second frame by estimating movements of the specific subject and reflecting only part of the estimated movements.

22. The apparatus of claim 12, further comprising an automatic renewal part for detecting the specific subject from the at least part of the whole region in the second frame by using the subject detection technology and automatically resetting the second block in the second frame based on the region corresponding to the detected specific subject, if there occurs a sudden change between an outward appearance of the specific subject in the first frame and that in the second frame which exceeds the pre-set degree.

23. A medium recording a computer readable program to execute the method of claim 1.
